(19) United States
(12) Patent Application Publication
(10) Pub. No.: US 2021/0379669 A1
(43) Pub. Date: Dec. 9, 2021

(54) DEVICE FOR PRODUCING A MOULDED BODY

(71) Applicant: REALIZER GMBH, Borchen (DE)

(72) Inventor: Matthias Fockele, Borchen-Alfen (DE)

(73) Assignee: REALIZER GMBH, Borchen (DE)

(21) Appl. No.: 16/976,369

(22) PCT Filed: Feb. 25, 2019
(86) PCT No.: PCT/EP2019/054621

§ 371 Date: Aug. 27, 2020

(30) Foreign Application Priority Data
Feb. 28, 2018 (DE) 10 2018 203 013.8

(51) Int. Cl. B22F 12/70; B33Y 30/00; B33Y 50/02; B33Y 40/00; B28B 1/00; B28B 17/00; B22F 10/85; B22F 12/41; B22F 12/60; B22F 12/90; B23K 26/342

(52) U.S. Cl. CPC B22F 12/70; B33Y 30/00; B33Y 50/02; B33Y 40/00; B28B 1/001; B23K 26/342; B22F 10/85; B22F 12/41; B22F 12/60; B22F 12/90; B28B 17/0081

(57) ABSTRACT

The invention relates to an apparatus for remelting material powder in layers to form a shaped body in a process chamber. The apparatus has a carrier for the layer build-up and an irradiation device for irradiating the powder in accordance with cross-sectional regions of the shaped body associated with the shaped body layers to be produced. A powder layer levelling and smoothing device having a smoothing slide for homogenising an amount of material powder on the carrier is provided, as well as an extraction device having a suction nozzle for extracting process smoke. The suction nozzle is movable in motor-driven fashion in the process chamber. Said suction nozzle is coupled to the smoothing slide for joint movement and is operable in suction mode during the joint movement, the irradiation device being active for irradiating the powder.

The invention relates to an apparatus for producing a shaped body by building it up in layers from powdered, in particular metallic or ceramic material in a process chamber, said apparatus comprising
a process control device,
a carrier for the layer build-up,
an irradiation device for irradiating the material powder layer currently being prepared at the top on the carrier in a cross-sectional region of the shaped body associated with this layer with radiation, in particular focused laser radiation, which causes the material powder in this cross-sectional region to be fused or possibly sintered by heating,
a levelling and smoothing device for preparing a material powder layer to be irradiated subsequently on the carrier, wherein the levelling and smoothing device comprises at least one smoothing slide movable in motor-driven fashion for homogenising and levelling a quantity of material powder on the carrier to form a material powder layer, and comprising
an extraction device, which has a suction nozzle apparatus for extracting process smoke from the process chamber,
wherein at least one suction nozzle of the suction nozzle apparatus is movable in the process chamber by means of a drive device, and wherein the suction nozzle is operable in suction mode during the movement, while the irradiation device is active for irradiating the relevant material powder layer currently being prepared on the carrier.

The invention relates in particular to the field of selective laser melting and, in respect of both the method and apparatus, is based on technology described for example in WO 2010/068327 A1, in DE 199 05 067 A1, in DE 101 12 591 A1, in WO 98/24574 A, in WO 2006/024373 A2, in WO 2017/084781 A1 and in DE 10 2006 014 835 A1.

The terms “selective laser melting”, “selective powder melting”, “selective laser sintering” and the like have become known in recent times as efficient methods for the production of objects even of relatively complex geometry, and these methods, which are often summarised under the term “rapid prototyping” or “rapid manufacturing” or “3D printing”, are essentially based on the following principle:

The object to be produced is built up layer by layer from a fine-grained, powdery raw material on the carrier in the process chamber in accordance with description data, for example CAD data or geometrical description data derived therefrom, by solidifying or fusing the raw material by location-selective irradiation in accordance with a cross-sectional pattern of the object associated with the layer in question. The irradiation is normally realised by means of laser radiation, with the beam deflection device of the irradiation device deflecting the laser beam being controlled by means of a control device on the basis of relevant geometrical description data of the object to be produced. The control information is usually processed and provided by a microcomputer.

The laser beam draws, on the raw material powder layer currently being prepared at the top on the carrier, the cross-sectional pattern of the object associated with this layer in order to selectively fuse the raw material according to the cross-sectional pattern. Afterwards, the preparation of the next material powder layer usually begins on the layer that was last selectively fused by irradiation in certain regions, whereupon an irradiation process then takes place again in the manner explained above. The object is thus created layer by layer, with the successively produced cross-sectional layers of the object being fused together so that they adhere to each other. Potential powder materials include various metals and alloys, for example including steel, titanium, gold, tantalum, aluminium, Inconel, etc. Ceramic material powder may also be used in selective laser melting. Furthermore, the method of selective laser melting may be used to produce almost any conceivable shape of objects, making it suitable for the production of complex shapes, machine elements, prostheses, jewelry, etc.

The relevant adjustment of the layer level relative to the beam source or the beam deflection device is normally achieved by lowering a platform which forms the carrier on which the object is built up layer by layer. In selective laser melting, the material powder used is usually irradiated in an inert gas atmosphere, for example an argon atmosphere, in particular to suppress oxidation effects. It is known to continuously purge the process chamber with inert gas during the selective laser melting process by letting in inert gas on one side of the process chamber, which inert gas is moderately extracted on the opposite side of the process chamber housing. The extracted inert gas may be returned to the process chamber in a circuit, if necessary after filtering.

When remelting the material powder by irradiation, a greater or lesser amount of process smoke is produced by evaporation effects, depending on the operating conditions. In relevant prior art apparatuses, the process smoke rises in the process chamber and is deposited at least in part as condensate on the inner walls of the process chamber, in particular on the ceiling of the process chamber and on other surfaces in the process chamber. The process chamber and installations located therein thus gradually become increasingly contaminated by condensate separation. This also affects components of the irradiation device, such as windows, lenses and the like. The contamination of such a component of the irradiation device means that some of the radiation is absorbed by the condensate material and thus is not available for remelting of the material powder. In addition, undesirable heating effects may occur at the relevant component of the optical irradiation device by absorption. Smoke gas in the beam path of the laser beam may also scatter or absorb the laser beam, which is unfavourable.

During remelting of certain material powders, in particular during remelting of titanium powder, process smoke may be produced, the condensate of which, initially deposited in the process chamber in an inert gas atmosphere, is highly reactive in the event of subsequent contact with air and tends towards spontaneous self-ignition or flame formation when critical quantities accumulate.

During remelting of the material powder, flying sparks are usually also produced, and therefore melt spatters may land on areas of remelted powder that have already been joined together and/or on walls of the process chamber or on equipment located therein, and may adhere there as solid particles in an undesirable manner, unless countermeasures are taken.

EP 1 839 781 B1 describes an apparatus for producing objects by building them up in layers from powdered material, in which measures are taken to avoid the precipitation of smoke gas at critical points in the process chamber. These measures comprise the passing of inert gas through the process chamber by means of an inert gas conveying device which has means for creating and maintaining a separation zone, which is almost impenetrable to process smoke, in the form of an inert gas flow layer between the construction area and the side of the process chamber housing opposite the construction area at the top. The process smoke is discharged from the process chamber with inert gas and fed to a filter station so that the inert gas may be reused after filtering if necessary.

The technical background also includes EP 2 431 113 A1, which shows a suction device and sensors for monitoring the formation of gas in the process chamber, and US 2011/0285060 A1, which shows the successive use of a plurality of separately movable tools within the scope of the formation of a new powder layer.

An apparatus corresponding to the preamble of claim 1 is known from WO 2014/199150 A1.

The object of the present invention is to provide an apparatus of the type mentioned at the outset having a versatile smoke gas discharge concept.

To achieve this object, an apparatus according to claim 1 is proposed. Advantageous refinements are the subject of the dependent claims.

Proceeding from an apparatus of the type mentioned at the outset, it is proposed in accordance with the invention that the at least one suction nozzle movable in the process chamber is coupled to the smoothing slide for joint movement, such that the drive device of the suction nozzle is at the same time the drive device of the smoothing slide for moving said slide.

In accordance with the invention, the at least one movable suction nozzle is coupled to the smoothing slide of the levelling and smoothing device for joint movement, such that the drive device of the suction nozzle is at the same time the drive device of the smoothing slide.

Preferably, the suction nozzle and the smoothing slide are coupled to each other via a common frame. Preferably, the drive device moves this common frame. Furthermore, it is also possible to further refine the smoothing slide by means of a displacement device which is displaceable vertically relative to the common frame.

In accordance with the apparatus according to the invention, the suction nozzle of the suction device may in most cases be placed very close to the location of the momentary remelting of the powder and thus to the source of the smoke gas. This means that the smoke gas and also melt splashes may be largely captured by the suction nozzle immediately after their formation and thus have hardly any possibility of settling on process chamber walls or other components in the process chamber.

In accordance with one embodiment of the invention, a collection plate for melt splashes is coupled to the movable suction nozzle and protrudes outwards below the suction nozzle in the immediate vicinity thereof. In many cases, the suction nozzle may also extract melt splashes towards and away from the collection plate.

In a preferred process control mode, the process control device is configured to coordinate the mode of operation of the irradiation device and also of the levelling and smoothing device and the suction device, in such a way that the distance between the suction nozzle active for process smoke extraction and the current location of irradiation of the powder layer is as small as possible and does not exceed a specific maximum value. The maximum value is preferably between 3 and 15 cm.

Preferably, the apparatus according to the invention also comprises an inert gas system which maintains an inert gas circuit through the process chamber during operation. The suction nozzle may be connected to an inert gas circuit so that smoke gas and, if necessary, flying spark condensate with extracted inert gas is removed from the process chamber and preferably fed to a filter system in order to be filtered out. A cyclone filter may be provided to filter out coarse particles.

In accordance with one embodiment of the invention, the processes of preparing the uppermost material powder layer on the one hand and the location-selective irradiation of the material powder layer as well as the smoke gas extraction on the other hand are executable separately and in succession.

In accordance with a variant of the invention, as they sweep over the construction area on the carrier, the suction nozzle and the smoothing slide may perform their functions simultaneously during the movement, namely extracting the smoke gas on the one hand and homogenising and levelling the powder on the other. Meanwhile, the irradiation device may be effective in remelting material powder in the regions of the construction area which has already been homogenised immediately before by the levelling and smoothing device. This mode of operation thus allows the apparatus to work quickly with very efficient smoke gas removal.

The at least one suction nozzle on the smoothing slide is preferably connected to an external suction source of the extraction device via a movable flexible line or telescopic line.

According to a preferred variant, the suction nozzle has a wide nozzle shape with a width extending at least approximately over the entire width of the construction area transverse to the direction of movement of the suction nozzle.

According to one embodiment, a plurality of smaller nozzle channels may be provided next to each other in the wide nozzle. In accordance with a variant of this embodiment, such nozzle channels may be switched on and off individually or in groups separately under the control of the process control device.

The suction nozzle is preferably arranged so that it follows the smoothing slide as it moves over the construction area.

Preferably, the suction nozzle is operable in suction mode also when the smoothing slide is at a standstill. In this case, the smoothing slide may be stopped in a position above the construction area. It may also be parked to the side of the construction area when the suction nozzle is active.

Preferably, the smoothing slide is designed in such a way that it is operable when moving in a first horizontal direction across the construction area—and also when moving in the direction across the construction area opposite the first movement—to homogenise and level an amount of material powder over the last irradiated layer, and in such a way that the suction nozzle apparatus is also designed such that it is operable in suction mode independently of the direction of movement of the smoothing slide. This improves the operating versatility of the apparatus.

A further preferred embodiment of the invention is characterised in that the smoothing slide has various smoothing slide elements, namely, in succession in the direction of movement of the smoothing slide during homogenisation and levelling operation, at least one brush element, at least one blade element, and at least one rubber-like element, in particular a silicone element, with a substantially flat horizontal lower scraping surface. Such a smoothing slide has proved to work very well. In particular, the smoothing slide elements may each be provided twice on the smoothing slide in a substantially symmetrical arrangement, and furthermore at least one further suction nozzle is provided in addition to the at least one suction nozzle in an at least approximately symmetrical arrangement thereto. As a result of such a design of the smoothing slide and the suction nozzle arrangement, the same conditions for the homogenisation process and fundamentally also for the suction process may be maintained during the back and forth movements of the smoothing slide.

Preferably, a powder dispensing device is located centrally between the smoothing slide elements for depositing the material powder on the carrier during the movement of the smoothing slide.

Preferably, the powder dispensing device is coupled to the smoothing slide and the at least one suction nozzle for joint movement, so that the drive device of the smoothing slide and the suction nozzle is at the same time the drive device of the powder dispensing device for moving said device.

In case of a common frame of suction nozzle and smoothing slide, the powder dispensing device is preferably coupled to the at least one suction nozzle and the smoothing slide via the common frame.

In the case of relative vertical displaceability of the smoothing slide by means of the displacement device, it is preferable that the powder dispensing device together with the smoothing slide is displaceable vertically relative to the common frame by means of the displacement device.

In general, when coupling the powder dispensing device to the smoothing slide and suction nozzle for joint movement with the smoothing slide and the at least one suction nozzle, the aforementioned symmetrical arrangement with double smoothing slide elements and suction nozzles is preferred, in particular in that the symmetrical arrangement is symmetrical in relation to the powder dispensing device and/or in that the powder dispensing device in plan view touches an axis of symmetry about which the smoothing slide elements provided twice on the smoothing slide are symmetrical and/or in that the powder dispensing device is located centrally between the smoothing slide elements.

Since the suction nozzle apparatus is normally positioned close to the relevant remelting region during the irradiation operation of the apparatus, it is particularly suitable for the arrangement of an image sensor device, for example a CCD sensor array or a corresponding camera, which is oriented to take an image of this remelting region and may thus be used for the analysis of the melting process and/or powder preparation device. This could be, for example, a preferably wireless web camera. One embodiment of the invention provides for at least one such image sensor device. The image may be displayed on a screen monitor. It is also possible to evaluate the image information automatically, for example by means of the process control device, in order to be able to make automatic corrections if necessary, for example to adjust the intensity of the radiation source. Spectral imaging systems may also be provided for this purpose.

It should also be noted that the suction device with its suction nozzle apparatus is also suitable as a carrier of radiation sources for heating the material powder, as it is operationally positioned close to the remelting region and therefore radiation sources arranged thereon may irradiate the remelting region from a short distance and thus heat it. These radiation sources are preferably additional radiation sources, such as high-power infrared emitters.

In a further development, for the build-up process, such radiation sources could also be arranged, if necessary, as primary radiation sources or even as the only radiation sources on the movable suction device or the assembly formed of suction nozzle apparatus and layer preparation device, for example as radiation source matrices or laser devices.

An interesting refinement of the invention provides that the apparatus has an inert gas injection apparatus having at least one inert gas injection nozzle, which inert gas injection apparatus is movable in motor-driven fashion in the process chamber. Preferably, the inert gas injection apparatus is coupled to the suction nozzle apparatus for joint movement so that the at least one inert gas injection nozzle of the inert gas injection apparatus and the at least one suction nozzle of the suction nozzle apparatus are not too far apart from one another. Inert gas extracted from the suction nozzle together with process smoke may thus be completely or partially replaced in the process chamber by means of the inert gas injection nozzle, so that the gas flows generated in this way noticeably affect the smallest possible region of the process chamber housing.

In addition, the injected inert gas, for example argon, may keep process smoke away from certain points of the process chamber and in particular may drive it towards the suction nozzle.

The aspect of the inert gas injection apparatus, which is movable in motor-driven fashion in the process chamber, especially together with the suction nozzle apparatus, may be of inventive significance independently.

Embodiments of the invention will be explained in greater detail below with reference to the drawings.

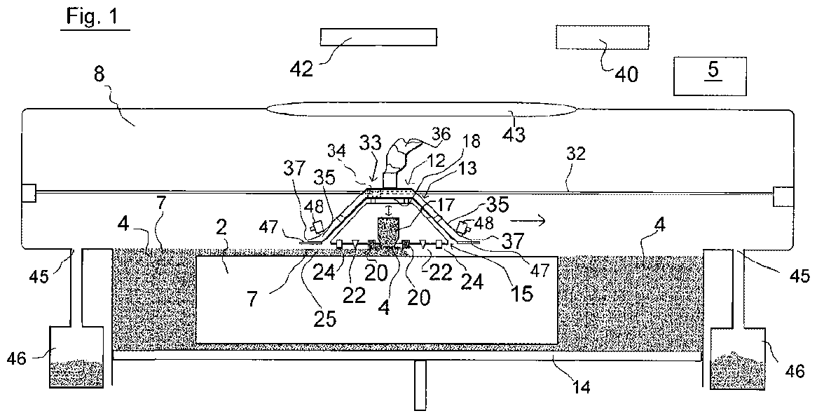

FIG. 1 is a schematic sectional view of an apparatus for the production of objects according to the invention from the front looking into the process chamber, wherein FIG. 1 shows the levelling and smoothing device in its operating state of preparation of a new upper material powder layer.

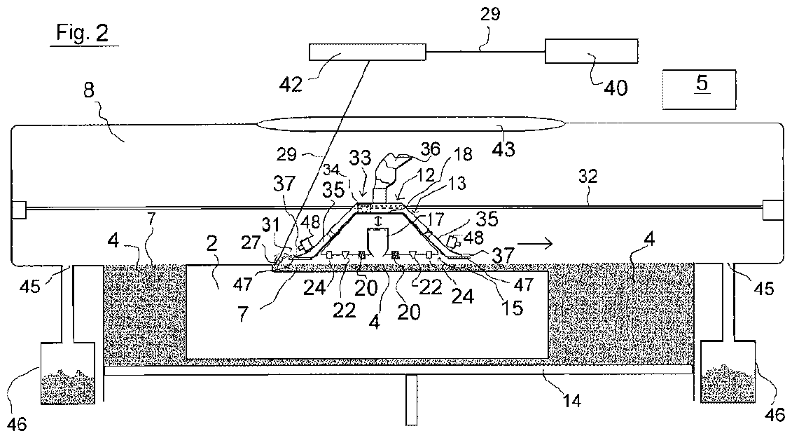

FIG. 2 is a representation corresponding to FIG. 1 of the apparatus for the production of objects in an operating state in which the previously prepared uppermost material powder layer is irradiated location-selectively and process smoke is extracted.

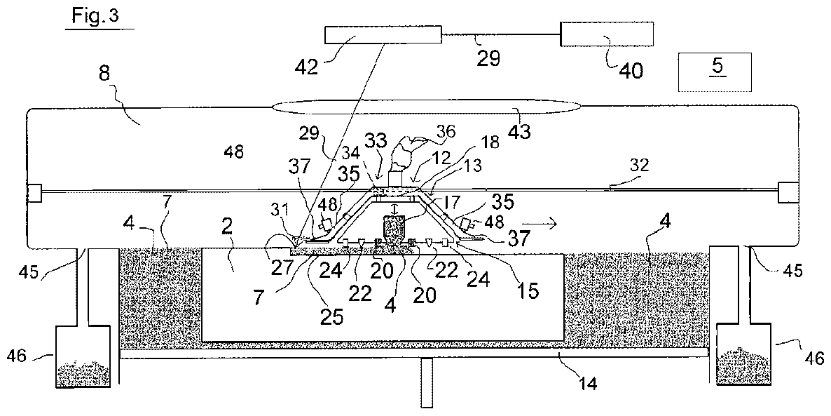

FIG. 3 is a representation corresponding to FIG. 1 or FIG. 2 of the apparatus for the production of objects in a special operating mode, according to which the preparation of the upper material powder layer, the irradiation of this layer at points where it is already finished, and the extraction of process smoke occur simultaneously.

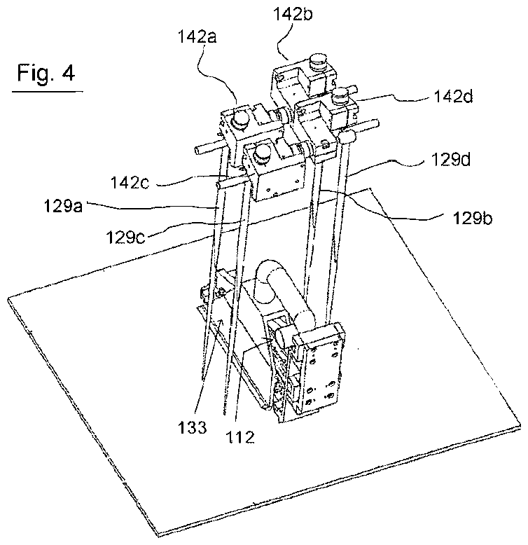

FIG. 4 is a schematic perspective view of components of another embodiment of the invention.

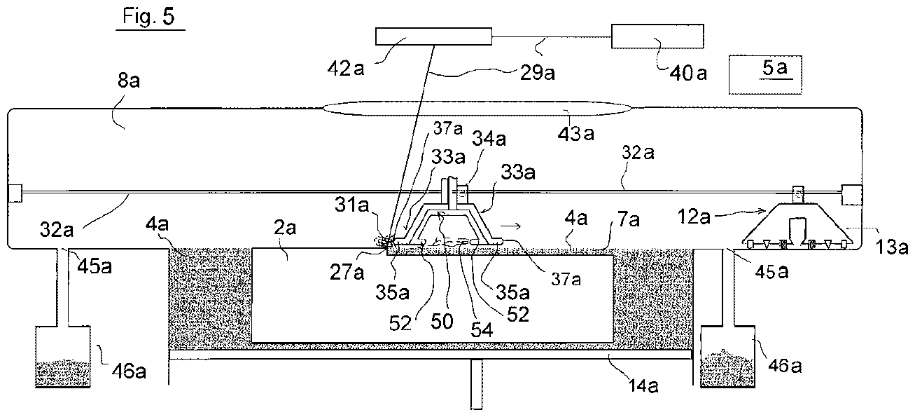

FIG. 5 is a representation corresponding to FIG. 1 to 3 of a further embodiment of the invention.

The explanatory sketch according to FIG. 1 shows a snapshot of a powder layer preparation step within the scope of the production of an object 2 by building up layers of a powder 4, for example titanium powder having a grain size of, for example, 10 μm to 60 μm or steel powder of corresponding grain size. The object 2 is built up in a process chamber 8, which is delimited by the process chamber housing. An inert gas atmosphere, preferably an argon atmosphere, prevails in process chamber 8, while an inert gas circuit (not shown) is maintained through the process chamber 8. The object 2 is built up in layers on a carrier platform 14, which is movable vertically and can be positioned in various vertical settings under the control of a vertical drive unit. A powder layer preparation device 12 having a levelling and smoothing device 13 is used to prepare the following material powder layer 7 on the carrier 14. The powder layer preparation device 12 is movable from left to right and from right to left in FIG. 1 over the entire construction area and thus over the entire carrier 14. It has a central powder dispensing reservoir 17 extending across the entire construction area transversely to the drawing plane, from which it may deposit material powder to form a new upper powder layer 7 on the construction area during the movement of the layer preparation device 12. To the left and right of the powder dispensing reservoir 17, the layer preparation device 12 has three different smoothing slide elements 20, 22, 24 on a smoothing slide 15 in a symmetrical arrangement on each side. The smoothing slide element 20 is a plastics brush. The smoothing slide element 22 is a metallic blade with a lower tip. The smoothing slide element 24 is a silicone block having a flat scraping surface at the bottom. During a powder coating process, the three coating elements 20, 22, 24 each come into effect and follow the powder dispensing reservoir 17 in the direction of movement of the smoothing slide 15. They ensure an evenly smoothed flat material powder surface of the new upper powder layer 7 being formed on the carrier 14. Since the layer preparation device 12 is operable both when moving from left to right over the construction area and when moving from right to left over the construction area to prepare an uppermost powder layer 7, the sets of stripping elements 20-24 are used depending on the direction of movement of the layer preparation device 12.

In the illustration according to FIG. 1, the layer preparation device 12 having the smoothing slide 15 moves from left to right and is in the process of forming an upper powder layer 7.

FIG. 1-3 show a support and guide rail for the layer preparation device 12, denoted by 32. This rail 32 extends horizontally along the rear wall of the process chamber. It also interacts with an electric motor drive device 34 of the layer preparation device 12 by allowing a drive wheel of this drive device 34 to roll on the rail 32 in order to thus generate a propulsion of the layer preparation device 12 under control of the process control device 5.

Once the powder layer preparation device 12 has passed over the carrier 14 and left behind a powder layer 7, excess powder that has already come out of the powder reservoir 17 may fall through an overflow opening 45 into a powder collection container 46. The powder dispensing reservoir 17 may be closed beforehand, so that powder in it may be kept ready for the next powder layer preparation process.

FIG. 2 shows the apparatus for the production of objects in an operating state in which the powder layer shown in FIG. 1 during the production process has already been prepared and the location-selective irradiation of this powder layer 7 is now taking place in a cross-sectional region of the object to be produced associated with this layer. An irradiation device 40, 42 is provided for this purpose, which comprises a laser 40 and a controllable beam deflection device (scanner) 42. By means of the irradiation device 40, 42 every point on the construction area is reachable by the laser beam 29 of the irradiation device 40, 42 in accordance with the control by the process control device 5. Reference numeral 27 shows the momentary point of impact of the laser beam 29 and thus the powder remelting point. There, the material powder 4 is momentarily being remelted. This usually results in smoke gas 31 and possibly flying sparks. A suction nozzle apparatus 33 having two suction nozzles 35 arranged on a frame 18 of the smoothing slide 15 serves to capture at least a large part of this smoke gas 31 and any sparks or melt splashes. The suction nozzles 35 are wide nozzles which extend at least substantially over the entire width of the construction area transversely to the plane of the drawing and have nozzle openings 37, directed laterally outwards, arranged on the frame of the smoothing slide 15, laterally outwardly of the smoothing slide elements 20-24. Alternatively, the wide nozzles could also be replaced by rows of individual nozzles arranged side by side or could contain such nozzles. The inert gas extracted from the process chamber 8 by the suction nozzle apparatus 33 is continuously replaced by an inert gas supply (not shown). This may be done within the scope of an inert gas filter and recycling process.

FIG. 2 shows that the suction nozzle 35 located on the left side of the smoothing slide 15 is positioned close to the current remelting point 27, so that it may intercept smoke gas 31 and any sparks from the remelting location. The process control device 5 ensures that the laser beam 29 and the assembly 12, 33 formed of layer preparation device 12 and suction nozzle apparatus 33 do not overlap with each other by controlling the beam deflection device 42 and the movement of the assembly 12, 33 accordingly. The drive device 34 of the powder layer preparation device 12 is at the same time also the drive device of the suction nozzle apparatus 33, since the powder layer preparation device 12 and the suction nozzle apparatus 33 are coupled via a common frame 18, which may be driven by the drive device 34 along the guide rail 32.

A collection plate for melt splashes is denoted by 47. The collection plate 47 is attached to the bottom of the corresponding suction nozzle 35 so that it protrudes outwards beyond the edge of the suction nozzle 35. It extends at a very small distance of, for example, 0.5 mm-2 mm above the powder bed. It has been found that such collection plates are very well suited for the collection of melt splashes which are moved in the relevant direction by the suction of suction nozzle 35.

An image sensor device, for example a wireless web camera, which is arranged on the assembly 12, 33 near the nozzle opening 37—and is directed towards the construction area so that the corresponding remelting region 27 may be observed (melt pool analysis) is denoted by 48. The quality of the powder layer 7 during its production may also be monitored in this way.

After the process step of irradiating the material powder layer 7 has been carried out, the carrier 14 may be lowered by the thickness of the next following material powder layer, so that the powder layer preparation device 12 may then prepare a next uppermost material powder layer 7, if necessary during the return journey from the right end to the left end of the process chamber 8.

The smoothing slide 15 is displaceable vertically by a small amount, controlled by means of a displacement device (not shown). In the preparation of powder layers according to FIG. 1, it is in its lowered position. During the irradiation process according to FIG. 2, it is in its raised position.

FIG. 3 shows a special mode in which the apparatus for the production of objects is in an operating state in which it simultaneously prepares the uppermost powder layer 7, selectively irradiates the layer with the laser beam 29 at locations where the layer is already finished, and extracts process smoke 31 and possibly flying sparks by means of the suction nozzle apparatus 33 near the relevant beam impact point 27. FIG. 3 also shows a situation in which the layer preparation device 12 moves from left to right with the smoothing slide 15.

In a rear region 25, which the layer preparation device 12 has already passed with its smoothing slide 15, the irradiation device 40, 42 has already begun with the location-selective irradiation of the upper material powder layer 7, and there the powder 4 has been remelted in accordance with the geometrical specifications of the shaped body 2. The powder layer preparation process and the selective irradiation of the uppermost layer 7, including the extraction of process smoke and melt splashes, may thus take place simultaneously in the special mode of the apparatus.

FIG. 4 shows individual components of a further embodiment of the invention in a perspective view of the construction area obliquely from above. The embodiment according to FIG. 4, similarly to the embodiment described above, also comprises an assembly 112, 133 movable in motor-driven fashion formed of powder layer preparation device 112 and suction nozzle apparatus 133. FIG. 4 shows this assembly in an oblique view from above and from behind. In FIG. 4, 142a-142d denote four different irradiation subsystems with respective beam deflection devices. Each of these subsystems 142a-142d directs its own laser beam 129a, 129b, 129c or 129d onto the construction area in order to remelt, in a controlled manner, powder of a previously prepared uppermost material powder layer according to geometrical description data of the object to be produced or, if applicable, of the objects to be produced, if a plurality of objects are to be produced simultaneously. The irradiation subsystems may be operated individually, in groups or all together simultaneously depending on the control by the process control device. This allows the time-saving processing of even large construction areas. The suction nozzles on both sides of the assembly 112, 133 may also be operated simultaneously.

The operation of the embodiment according to FIG. 4 may in principle be carried out according to the operation already explained above for the first embodiment of the invention; however, in the embodiment according to FIG. 4 the controller has to take into account the presence of a plurality of laser beams.

FIG. 5 shows a further embodiment of the invention in a representation corresponding to the representation in FIG. 1-3. Components and elements of the embodiment according to FIG. 5 which substantially correspond to components or elements of the embodiments according to FIG. 1-3, representationally or functionally, are denoted in FIG. 5 by correspondingly identical reference numerals with the addition of a lowercase letter ‘a’, and therefore in essence the differences between the embodiment according to FIG. 5 and the previous embodiments of FIG. 1-3 may be discussed hereinafter in order to explain the embodiment according to FIG. 5.

A special feature of the embodiment shown in FIG. 5 is that the suction nozzle apparatus 33a and the powder layer preparation device 12a are separated from each other. FIG. shows a snapshot of the apparatus according to the invention in an operating state of the location-selective irradiation of the powder layer 7a, which has already been prepared beforehand by means of the powder layer preparation device 12a. The powder layer preparation device 12a is located in FIG. 5 in a parked state to the right of the construction area.

Reference numeral 27a denotes the momentary point of impact of the laser beam 29a and thus the powder melting point. This is where the material powder 4a is momentarily being remelted. The suction nozzle apparatus 33a, which has suction nozzles 35a having suction nozzle openings 37a, serves to capture at least a large part of the smoke gas 31a and any sparks or melt splashes produced during this process. FIG. 5 shows that the suction nozzle apparatus 33a is momentarily moving to the right. The suction nozzle 35a located on the left side of the suction nozzle apparatus 33a is momentarily positioned close to the remelting point 27a, so that it may optimally intercept smoke gas 31a and any sparks. The process control device 5a ensures that the laser beam 29a and the suction nozzle apparatus 33a do not overlap by controlling the beam deflection device 42a and the movement of the suction nozzle apparatus 33a accordingly.

An advantageous special feature of the embodiment according to FIG. 5 is an inert gas injection apparatus 50 which is movable with the suction nozzle apparatus 33a. FIG. 5 shows the preferred embodiment according to which the inert gas injection apparatus 50 is coupled to the suction nozzle apparatus 33a for joint movement. In modified embodiments, however, the inert gas injection apparatus 50 may also have its own drive means controllable by means of the control device 5a and may thus be independently movable.

The inert gas injection apparatus 50 has two inert gas injection nozzles 52, by means of which inert gas 54 is introducible into the process chamber 8a. This inert gas may completely or partially replace the inert gas extracted with process smoke 31a by the suction nozzle apparatus 33a. However, other inert gas feeds, in particular stationary inert gas feeds to the process chamber 8a, may also be provided. This also applies for inert gas discharges.

In the situation according to FIG. 5, the left-hand suction nozzle 35a, directly adjacent to the beam impact point 27a, is active in order to extract process smoke 31a and any melt splashes. At the same time, the right-hand inert gas injection nozzle 52 of the inert gas injection apparatus 50 is momentarily active in order to blow inert gas in the direction of the active suction nozzle 35a. In this way, smoke gas tends to be prevented from reaching the region below the assembly formed of suction nozzle apparatus 33a and inert gas injection apparatus 50.

The nozzles 35a and 52 are controllable by means of the control device 5a, so that one, two, three or all nozzles 35a, 52 may be switched on, depending on the desired operating mode.

It should also be noted at this juncture that combinations of the embodiments according to FIG. 1-5 are possible. For example, an inert gas injection apparatus may be coupled together with a suction nozzle apparatus and a layer preparation apparatus for joint movement.

In the simplified embodiment according to FIG. 5, it is not shown separately that the assemblies 33a, 50 on the one hand and 12a on the other hand may pass each other at a crossing point, so that the layer preparation device 12a may always be active ahead of the assembly formed of extraction device 33a and inert gas injection apparatus 50, regardless of the direction of movement in the process chamber 8a. A noble gas, for example argon, is particularly suitable as the inert gas.

1. An apparatus for producing a shaped body by building it up in layers from powdered material in a process chamber, said apparatus comprising:
a process control device;
a carrier positioned within a process chamber and on which a quantity of material powder is deposited during a layer build-up process;
an irradiation device controlled by the process control device to irradiate with radiation g material powder layer being prepared on the carrier in a cross-sectional region of a shaped body associated with the material powder layer, which causes the material powder in the cross-sectional region to be fused or sintered by heating;
a levelling and smoothing device positioned within the process chamber and controlled by the process control device to prepare the material powder layer to be irradiated on the carrier, wherein the levelling and smoothing device comprises at least one smoothing slide movable in motor-driven fashion for homogenising and levelling the quantity of the material powder on the carrier to form the material powder layer; and
an extraction device, which has a suction nozzle apparatus controlled by the process control device to extract process smoke from the process chamber, wherein at least one suction nozzle of the suction nozzle apparatus is movable in the process chamber by a drive device, and wherein the suction nozzle is operable in suction mode during movement while the irradiation device is active for irradiating the material powder layer on the carrier, wherein the smoothing slide is movable relative to a current location of irradiation, and wherein the at least one suction nozzle is coupled to the smoothing slide for joint movement, such that the smoothing slide is also moveable by the drive device.

2. The apparatus according to claim 1, wherein the at least one suction nozzle and the smoothing slide are coupled via a common frame, the drive device driving the common frame.

3. The apparatus according to claim 2, wherein the smoothing slide is displaceable vertically relative to the common frame by a displacement device.

4. The apparatus according to claim 1, wherein the process control device in a process control mode is configured to coordinate g mode of operation of the irradiation device and of the suction device with one another, in such a way that a distance between the suction nozzle active for process smoke extraction and the current location of irradiation of the material powder layer does not exceed a specified maximum value.

5. The apparatus according to claim 1, wherein the process control device is configured to control the movement of the suction nozzle active for process smoke extraction, in such a way that g distance between the suction nozzle active for process smoke extraction and the current location of irradiation of the material powder layer does not exceed a specified maximum value.

6. The apparatus according to claim 1, wherein the irradiation device comprises a laser for generating a laser beam as the radiation and a beam deflection device, the process control device being configured to control the beam deflection device and the movement of an assembly comprising the levelling and smoothing device and the suction nozzle apparatus such that the laser beam and the assembly do not overlap with one another.

7. The apparatus according to claim 1, wherein the at least one suction nozzle is connected to an external suction source of the extraction device via a movable flexible line and/or telescopic line, wherein the external suction source is external to the process chamber.

8. The apparatus according to claim 1, wherein the at least one suction nozzle has a wide nozzle shape with a width corresponding at least approximately to a width of the carrier.

9. The apparatus according to claim 1, wherein the suction nozzle is arranged such that it follows the smoothing slide as it moves over the carrier to homogenise and level the quantity of material powder over the material layer after the material layer is irradiated.

10. The apparatus according to claim 1, wherein the suction nozzle is operable in the suction mode when the smoothing slide is at a standstill.

11. The apparatus according to claim 1, wherein the smoothing slide is operable when moving in a first horizontal direction across the carrier and also when moving in a second direction across the carrier opposite the first direction to homogenise and level the quantity of material powder, and wherein the suction nozzle apparatus is also designed such that it is operable in the suction mode independently of a direction of movement of the smoothing slide.

12. The apparatus according to claim 1, wherein a plurality of smoothing slide elements are arranged on the smoothing slide, and wherein the smoothing slide elements comprise, in succession in a direction of movement of the smoothing slide during homogenisation and levelling operation, at least one brush element, at least one blade element, and at least one rubber-like element with a flat horizontal lower scraping surface.

13. The apparatus according to claim 12, wherein the smoothing slide elements are arranged on the smoothing slide in a symmetrical arrangement, and wherein the symmetrical arrangement comprises a first brush element, a first blade element and a first rubber-like element arranged in succession on a first side of the smoothing slide extending away from the center of the smoothing slide and a second brush element, a second blade element and a second rubber-like element arranged in succession on a second side of the smoothing slide away from the center of the smoothing slide;
wherein each of the first rubber-like element and the second rubber-like element has a flat horizontal lower scraping surface; and
wherein the suction nozzle apparatus comprises a first suction nozzle proximate to the first side of the smoothing slide and a second suction nozzle proximate to the second side of the smoothing nozzle.

14. The apparatus according to claim 12, wherein a powder dispensing device is coupled to the smoothing slide and to the at least one suction nozzle for joint movement, such that the smoothing slide, the suction nozzle, and the powder dispensing device are moveable by the drive device.

15. The apparatus according to claim 2 further comprising a powder dispensing device, wherein the powder dispensing device is coupled to the at least one suction nozzle and the smoothing slide via the common frame.

16. The apparatus according to claim 15, wherein the powder dispensing device together with the smoothing slide is displaceable vertically relative to the common frame by a displacement device.

17. The apparatus according to claim 14, wherein the symmetrical arrangement is symmetrical in relation to the powder dispensing device.

18. The apparatus according to claim 1, further comprising a device for generating an inert gas atmosphere in the process chamber.

19. The apparatus according to claim 1, further comprising a collection plate for melt splashes, wherein the collection plate is coupled to the movable suction nozzle and protrudes outwards below the suction nozzle.

20. The apparatus according to claim 1, wherein the irradiation device comprises a plurality of irradiation subsystems, wherein the plurality of irradiation subsystems are simultaneously controllable by the process control device to remelt material powder selectively at different points of the material powder layer while the material power layer is being irradiated.

21. The apparatus according to claim 1, wherein an image sensor device is arranged close to the suction nozzle apparatus and is movable therewith, the image sensor device being operable to capture images of g particular remelting region.

22. The apparatus according claim 1, wherein a radiation heating device is arranged close to the suction nozzle apparatus and is movable therewith, the radiation heating device being operable to heat the material powder at g particular remelting region.

23. The apparatus according to claim 1, further comprising an inert gas injection apparatus having at least one inert gas injection nozzle, wherein the inert gas injection apparatus is movable in motor-driven fashion in the process chamber.

24. The apparatus according to claim 23, wherein the inert gas injection apparatus is coupled to the suction nozzle apparatus for joint movement.

25. The apparatus according to claim 23, wherein the at least one inert gas injection nozzle is oriented towards the at least one suction nozzle of the suction nozzle apparatus.
